(19) United States
(12) Patent Application Publication
(10) Pub. No.: US 2004/0247090 A1
(43) Pub. Date: Dec. 9, 2004

(54) Process for providing alert notification to communication devices

(76) Inventor: Wayne Denis Nurmela, Quail Valley, CA (US)

Correspondence Address: Wayne Denis Nurmela, Suite #113, 31566 Railroad Canyon Rd., Canyon Lake, CA, 92587-9446, US

(21) Appl. No.: 10/455,471

(22) Filed: Jun. 5, 2003

(51) Int. Cl. H04M 1/64; H04M 11/00

(52) U.S. Cl. 379/88.13; 379/88.12

(57) ABSTRACT

A process for providing alert notification to communication devices, first utilizing data storage containing identifying criteria and device addresses of all persons capable of receiving alert messages. Second utilizing a set of criteria quickly predetermined by an end user to qualify which device addresses will receive the alert message. Third provides sending alert messages to qualified addresses of the devices whereby sending instant communication to precise groups of addressed devices. A preferred method of the alert notification system provides for two-way communication with the communication devices.

### CROSS REFERENCE TO RELATED APPLICATION

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of communications and more specifically to a process for providing alert notification to a variety of communication devices. Use of the telephone has been the primary form of instant communication for many years. However, trying to contact a large number of people in a very short period of time in cases of emergency, military recall or when a quick response is required has required very large telephone rooms or intricate recall rosters.

I first noticed a problem in 1999 after nearly 20 years in the medical field. A need would arise in a hospital for extra staff due to an increase in patients or low staffing. The nursing supervisor would contact several staffing agencies called medical registries. Each of the many registries would then search through a list of qualified employees and begin the process of calling them on their home phones, cell phones, pagers etc. It was not uncommon for a need to be filled hours later or not at all. I also remembered my time in the military when recalls would take place, each of us would have a list of about 5 people to call and would then be required to report back to the person who contacted us. This procedure would also take several hours to complete and many times we would only make contact with a family member or an answering machine.

I began to develop a more efficient system of notification for use during alert situations. This form of communication would only require short messages to be disseminated to a very large yet select group of people. I could see that there was a desperate need for very quick way to identify specific people by profession, skills, licenses and qualifications and then quickly notify them with the alert message they needed. This method of alert notification was developed to fill this specific need.

The telephone has been the primary form of communication for alert notification for many years. However, can only be used for a small group of people communicating at the same time.

Automatic dialing machines blended with a recorded message has been the closest attempt to contact a large number of people by phone without the aid of human intervention. Automated dialing devices are disclosed in U.S. Pat. No. 4,817,135 to Winebaum, U.S. Pat. No. 4,873,720 to Son, U.S. Pat. No. 4,882,750 to Henderson, et al., U.S. Pat. No. 4,980,910 to Oba et al., U.S. Pat. No. 5,182,767 to Bernard, U.S. Pat. No. 5,452,352 to Talton, U.S. Pat. No. 5,343,519 to Feldman, U.S. Pat. No. 5,455,857 to McGuire.

Radios have aided mass communications without selectivity.

Point to point communication devices; telephones, cell & satellite phones lack the ability to contact a multitude of people instantly like my invention does. Automated dialers can still only make a few phone calls at a time and must incur charges from the telephone company.

Mass communication devices; radios, television & public radio stations (used currently by the emergency broadcast system) lack the specificity needed to clarify who will be receiving the messages. An example is attempting to evacuate a city. Currently the forms of mass communications are unable to be geographically restricted.

Electronic forms of communication; e-mail, text messaging, electronic voice transmissions etc. are not capable as a stand alone option to, on-the-fly, qualify and alert notify a list of recipients.

None of the current technologies listed above can match the method of this invention's combining function of database storage, qualifying/filtering, list generation and delivery of alert messages to all forms of communication devices with the exception of non-ham radios.

### BRIEF SUMMARY OF THE INVENTION

The primary object of the invention is to provide a higher speed and control of alert communications. This alert notification system is able to contact thousands within 60 seconds while currently the most utilized method of notification takes hours. School districts contacting last minute substitutes, police departments contacting off duty officers for emergencies and homeland security contacting a large number of specialists in various agencies in response to specific emergency events all need to get alert messages out in seconds.

The secondary object of the invention is to provide a less labor-intensive way to deliver alert messages. Airlines, staffing companies, emergency agencies as well as many others must utilize large phone rooms to accomplish the task of alert notifications; while our system can notify thousands of qualified personnel for any specific emergency or event.

Another object of the invention is to provide a less expensive way to send and receive alert messages with large numbers of people. Since this system makes use of the Internet for all contact with text-messaging addresses and Internet Protocol Telephone it drastically reduces the customary expenses of telephone bills incurred during the notification process.

A further object of the invention is to provide a method of qualifying people who will need to be sent alert messages. Temporary staffing companies and others need to be able to find qualified, licensed and available individuals to place into open positions. This system allows complete flexibility of setting any parameters necessary for the industry using the system. Pre-qualifications as drug screenings, background check clearances and many others can be built into the search parameters of the database.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a process for providing alert notification to communication devices, comprising the steps of: (a) a means of storing data necessary for identification of said communication devices, (b) a means for qualifying said data into predetermined groups, (c) and a means for at least sending alert messages to said predetermined groups. Furthermore communication devices may respond to alert notifications creating a two-way communication system for emergency messaging and time sensitive instructions. Another additional application of this method is the process of checking for expired qualifications at a predetermined interval and sending alert notification to individuals requesting updated verification of qualifications. Another application of this method is the sending of graphical data or voice data to communication devices.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a flow chart of the operations that comprise the method in a general view.

FIG. 2 is a flow chart of the operations that comprise the method in a specific view.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

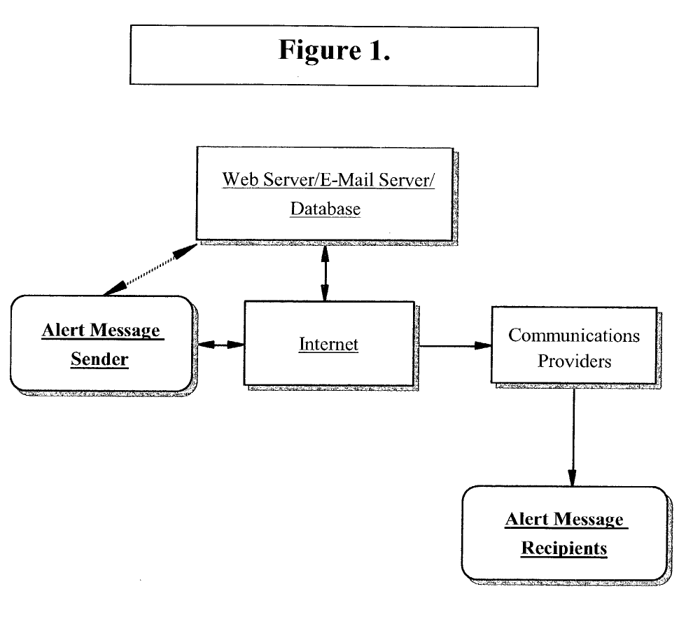

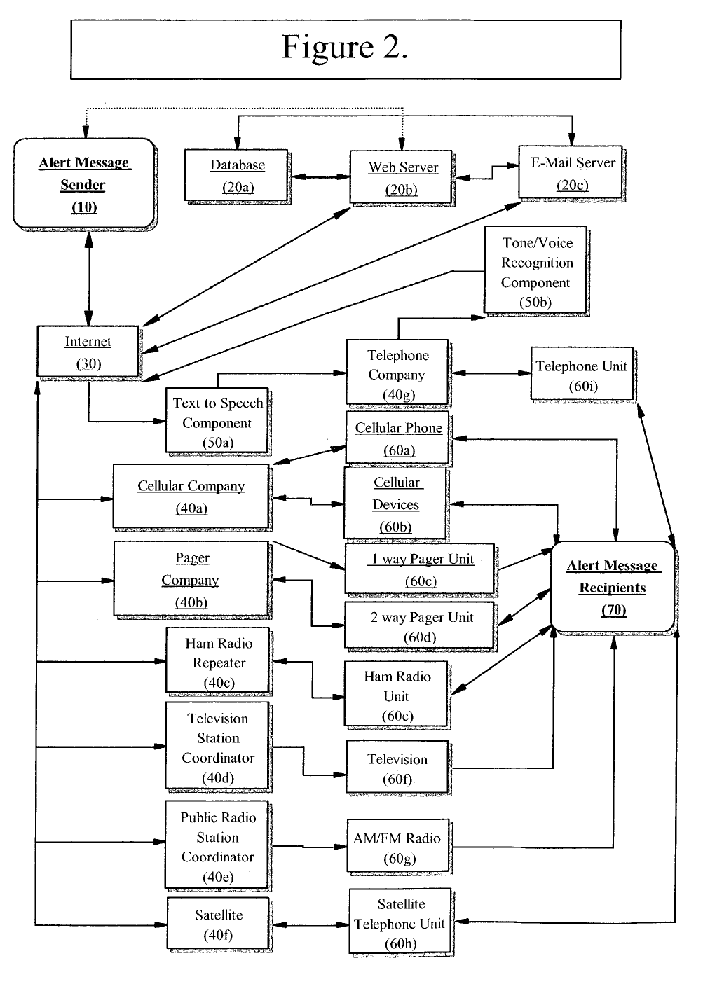

Simply stated; the process for providing alert notification to communication devices as hereinbefore set forth will glean from a database a list of device addresses matching the requested criteria from the message sender. The alert message is then delivered to the alert message recipients via their communication devices. This process has an average completion time of less than 60 seconds. Turning first to FIG. 1 there is shown an alert message sender on the left of the flow chart. This represents a military recall initiator, an airline crew scheduler, a staffing recruiter, an emergency agency employee or other person who would initiate an alert message (In carrying out the method of this invention the Internet may be used to provide access to a web server, e-mail server and database). The sender interacts with the database through the web server and selects the type of need the sender has to send an alert message. This need could be very specific or very broad. Some examples would be a national emergency, a need to evacuate a geographical area, an immediate opening for a nurse at a hospital, a military recall, a specialized response team for a local law enforcement agency or any other combination of requirements. The system can also verify availability and credentials if necessary for the need. The box labeled Communications Providers in FIG. 1 represents a multitude of communication providers as illustrated more specifically in FIG. 2. Preferably the message receiver is using a two-way communication device and can reply to the message for the purpose of responding to the alert message.

By way of further detailed illustration refer to FIG. 2. Note the red outlined boxes (text is underlined in red boxes if you are viewing a non-color rendition of the drawing) are included modules of independent claim A1. Box labeled (10) represents the sender defined in the previous paragraph. The boxes labeled (20) are considered to be the heart of this unique process of combining the searching of a database, configuration of an alert notification list of recipients from said database and actual notification of communication devices owned by said recipients. A dotted line connects the Sender and the Web Server to show that the Internet is not needed for sender access if sender owns a locally based web server. Turning your attention to box labeled, (30) you will recognize the primary transportation unit for data to disseminate itself from sender to receiver and back again. The alert notifications use the Internet in order to reach the communication providers illustrated by boxes labeled (40) in FIG. 2. Moreover each provider relays the alert notification to individual communication devices identified by boxes labeled (60) in the drawing. These messages are delivered in this way to the recipients shown in the drawing as the box labeled (70). Attention is drawn to the boxes labeled (50) in FIG. 2. These boxes represent translation equipment and/or computer software necessary to complete a voice to data and data to voice loop of communication with traditional telephone units.

Attention is drawn to the fact that data stored in the database and accessed by the web server and e-mail server all illustrated in FIG. 2 labeled (20) may contain a large array of information pertaining to the message recipient. This information may at the desire of the sender contain availability schedules linked from a scheduling program, expiration dates of licenses or other qualifying factors, preferences, skills, performance review rating, and an unlimited list of other data which is all available to set standards or qualifications for each alert notification generated in the process. Upon inspection of FIGS. 1 & 2 it will be seen that this process of combining a searchable database and a method of alert notification delivery to a multitude of communication devices with full message sender controls has the capability of revolutionizing a large number of industries, emergency response agencies, governments and military units by providing them with a process of alert message delivery within seconds rather than the current hours of work necessary to accomplish a similar outcome.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A process for providing alert notification to communication devices, comprising the steps of:
(a) a means of storing data necessary for identification of said communication devices;
(b) a means for qualifying said data into predetermined groups;
(c) and a means for at least sending alert messages to said predetermined groups.

2. A process for providing alert notification to communication devices, as claimed in claim 1 wherein said step (c) further including a text to speech means of said alert notification delivery to telephones.

3. A process for providing alert notification to communication devices, as claimed in claim 1 wherein said step (c) further including a means to receive replies to said alert messages from said communication devices whereby confirming said alert message delivery.

4. A process for providing alert notification to communication devices, as claimed in claim 1 wherein said communication devices are selected from the group consisting of:
(a) cellular telephones
(b) traditional telephones
(c) alphanumeric pagers
(d) wireless handheld devices
(e) personal computers
(f) laptop computers
(g) ham radio repeater stations
(h) satellite telephones
(i) a multitude of electronic addressable devices

5. A process for providing alert notification to communication devices, as claimed in claim 1 wherein said step (b) further including a means to monitoring expiring qualification components of said data whereby providing a means of requesting updated qualifications from owners of said communication devices.
